(19) United States
(12) Patent Application Publication
(10) Pub. No.: US 2009/0292998 A1
(43) Pub. Date: Nov. 26, 2009

(54) AGGREGATING AND SHARING KEYS OF WEB PAGES OVER PAGE VIEWERS

(75) Inventors: Amit Kumar, San Jose, CA (US); Ali Dasdan, San Jose, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/124,959

(22) Filed: May 21, 2008

(51) Int. Cl. G06F 3/00

(52) U.S. Cl. 715/738

(57) ABSTRACT

Disclosed are apparatus and methods for collecting information regarding areas or objects of interest of web pages, or other web objects. The areas or objects of interest are referred to herein as “keys”. In certain embodiments, as web pages are viewed by users, users can define one or more keys within the web pages and these defined keys are retained. Other key information may also be associated with such defined keys. The retained key, as well as other associated key information, may then be shared with users of such web page.

### BACKGROUND OF THE INVENTION

The field of the invention pertains to web pages that are viewed over a computer network.

In recent years, the Internet has been a main source of information for millions of users. There are numerous ways users can access and view information, such as web pages, via the Internet. One conventional way for users to search for information of interest to them is to initiate a search query through a search service's web page. Typically, a user can enter one or more search term(s) into an input box on the search web page and then initiate a search based on such entered search term(s). In response to a query, a web search engine generally returns an ordered list of search result documents. The list of search results typically each includes a title, a universal resource locator (URL) link, and an abstract or summary of the search result. The user can then view each search result indirectly by viewing the summary or view the search result itself by clicking the URL link. Another conventional way for users to view information via the Internet is to send a request for a specific web object, such as a web page, to a web server. The web server then provides the requested web page to the user for viewing.

As a user is viewing a particular web page either directly or indirectly through their summaries in web search results, for example, many web users may focus only on certain portions of each page. The portions of interest of a web page can be any area on the page, either the area itself or the content of the area, or both. For example, a word or a phrase can hold a user's interest for the particular web page. Various objects on the web page, such as a box showing an advertisement or some text, can also be an area of interest, regardless of its contents.

Although users are frequently accessing particular areas or objects of interest in viewed or accessed web pages and probably remembering these interest areas or object when the user is using such web pages, it would be beneficial to provide improved mechanisms for managing areas or objects of interest for users of web pages.

### SUMMARY OF THE INVENTION

Accordingly, apparatus and methods for collecting information regarding areas or objects of interest of web pages, or other web objects, are provided. The areas or objects of interest are referred to herein as “keys”. In certain embodiments, as web pages are viewed by users, users can define one or more keys within the web pages and these defined keys are retained. Other key information may also be associated with such defined keys. The retained key, as well as other associated key information, may then be shared with users of such web page.

In one embodiment, a method of viewing web pages via a computer network is disclosed. The method includes (a) when a particular web page is being accessed during a first time period by a first user, receiving input from the first user for defining a key within the particular web page, wherein the key is an area or one or more objects that are defined as being of interest to the first user, and (b) when a second user, who differs or is the same as the first user, accesses the particular web page during a subsequent time period, providing the key within the web page to the second user so that the key is provided to the second user as an area or one or more objects of interest within the web page.

In a specific implementation, the area or one or more objects of interest is one or more words of the web page that were defined as the key by the first user during the first time period. In another aspect, the area or one or more objects of interest is a specific area of the web page that was defined as the key by the first user during the first time period. In a further aspect, the key pertains to the content within the specific area. In another example, the method repeats operation (a) receiving input, from a plurality of first users who are the same or different users, for defining a plurality of keys within the particular web page. The second user is provided with one or more of the keys for such particular web page. In a further aspect, one or more metrics for the keys are determined, and the one or more metrics are provided to the second user.

In another example implementation, each of the keys or the entire set of keys include a permission setting that specifies sharing with a specific user, a set of specific users, or any user of the particular web page. For each of the keys, the second user is only provided with such each key if the second user is specified as having permission for such each key. In one aspect, the key includes a comment or tag that is associated with the area or one or more objects of interest. In another aspect, receiving the input from the first user is accomplished by tracking eye movement of the first user with respect to the particular web page.

In another embodiment, the invention pertains to an apparatus having at least a processor and a memory. The processor and/or memory are configured to perform one or more of the above described operations. In another embodiment, the invention pertains to at least one computer readable storage medium having computer program instructions stored thereon that are arranged to perform one or more of the above described operations.

These and other features of the present invention will be presented in more detail in the following specification of the invention and the accompanying figures which illustrate by way of example the principles of the invention.

### BRIEF DESCRIPTION OF THE DRAWINGS

FIG. 1 illustrates an example network segment in which the present invention may be implemented in accordance with one embodiment of the present invention.

FIG. 2 is a flow chart illustrating a key input procedure in accordance with one embodiment of the present invention.

FIG. 3A is a screen shot illustrating a key input mechanism for a particular web page in accordance with one embodiment of the present invention.

FIG. 3B illustrates a screen shot after the user has initiated a key definition for the web page of FIG. 3A in accordance with a specific implementation.

FIG. 4 is a flow chart illustrating a key sharing procedure in accordance with a specific implementation of the present invention.

FIG. 5 is a screen shot illustrating a web page for which key is provided in accordance with another example embodiment.

FIG. 6 illustrates an example computer system in which specific embodiments of the present invention may be implemented.

### DETAILED DESCRIPTION OF THE SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

In general, mechanisms for users to define keys within web pages are provided. The keys that are defined for such web pages may take any suitable form, such as text, images, videos, audio files, URL (universal resource locator) links, software plug-ins, or any object that can be selected, viewed, or otherwise accessed. The keys may also be defined for an entire object or part of an object. For example, the key for a text can include all the text on a web page or can include only part of it. Similarly, the key for a text may even take a different form, such as an image. A web page may have been initially accessed through any suitable application, such as a search or web service. As users define one or more keys for a particular web page, the one or more keys may be retained for later sharing with the same or a different user when accessing such particular web page. In one embodiment, when a user accesses a particular web page having one or more defined keys, one or more of these defined keys may be provided to the user as described further below. Since the keys may also be associated with the objects in such particular web page, the keys may also be shared when these objects are accessed through the same or different web pages.

Example embodiments of the present invention may be used to significantly enhance the search and/or web experience by remembering keys within web pages. In certain embodiments, users can learn from the knowledge of the community by sharing keys. The sharing of keys, for example, can help the users to more quickly focus on the important details of a web object, such as a document.

Although certain embodiments are described herein in relation to search result objects and the management of keys for such search results documents in the context of a search service application, it should be apparent that key management may also be provided in other applications, such as a music or video service for browsing or searching through audio visual objects. It should also be noted that embodiments of the invention are contemplated in which the operation of the underlying search or web engine is largely unaffected by the overlying key management. For instance, in response to a search query, a search engine may acquire information relating to the search query as it would conventionally, i.e., without the benefits of or reference to the key management enabled by the present invention. For example, key management techniques may be applied to the conventionally retrieved results. However, embodiments are also contemplated in which the operation of the underlying search engine is altered based on key information in some way to enable at least some further search enhancements as described further below. For example, the ranking of the search results may be affected by key information and the search engine may be revised based on the key information.

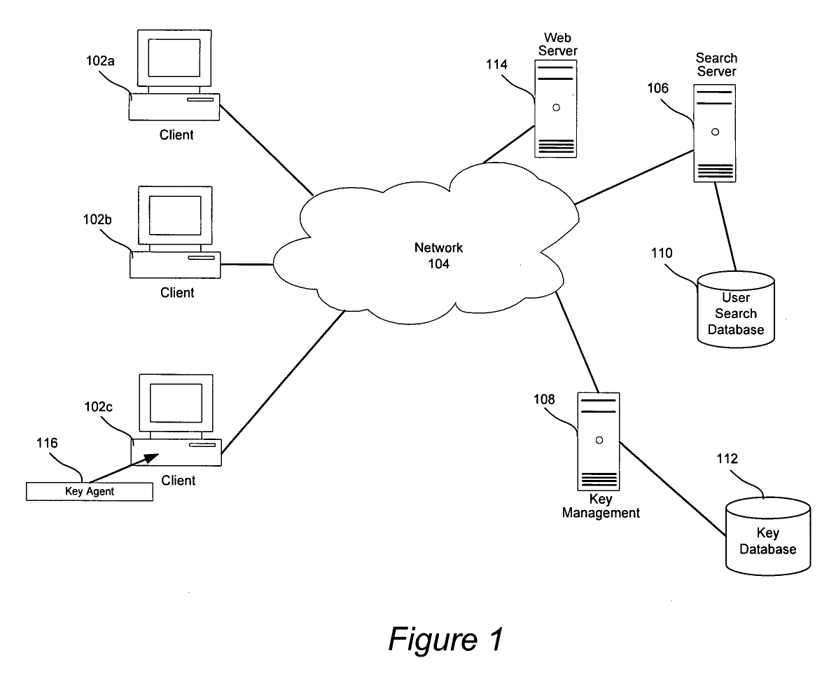

Prior to describing mechanisms for key management, a search and web architecture will first be briefly described to provide an example context for practicing techniques of the present invention. FIG. 1 illustrates an example network segment in which the present invention may be implemented in accordance with one embodiment of the present invention. As shown, a plurality of clients 102 may access a search application, for example, on search server 106 via network 104 and/or access a web service, for example, on web server 114. The network may take any suitable form, such as a wide area network or Internet and/or one or more local area networks (LAN's). The network 104 may include any suitable number and type of devices, e.g., routers and switches, for forwarding search or web object requests from each client to the search or web application and search or web results back to the requesting clients.

Certain embodiments of the invention may also be practiced in a wide variety of network environments (represented by network 104) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

A search application generally allows a user (human or automated entity) to search for information that is accessible via network 104 and related to one or more search terms. The search terms may be entered by a user in any manner. For example, the search application may present a web page having any input feature to the client (e.g., on the client's device) so the client can enter one or more search term(s). In a specific implementation, the search application presents an input box into which a user may type any number of search terms. Embodiments of the present invention may be employed with respect to any search application, and example search applications include Yahoo! Search, Google, Altavista, Ask Jeeves, etc. The search application may be implemented on any number of servers although only a single search server 106 is illustrated for clarity.

The search server 106 (or servers) may have access to one or more user search database(s) 110 into which search information is retained. Each time a user performs a search on one or more search terms, information regarding such search may be retained in the user search database(s) 110. For instance, the user's search request may contain any number of parameters, such as user or browser identity and the search terms, which may be retained in the user search database(s) 110. Additional information related to the search, such as a timestamp, may also be retained along with the search request parameters. When results are presented to the user based on the entered search terms, parameters from such search results may also be retained. For example, the specific search results, such as the web sites, the order in which the search results are presented, whether each search result is a sponsored or algorithmic search result, the owner of each search result, whether each search result is selected by the user (if any), and a timestamp may also be retained in the user search database(s) 110.

Key management module 108 may be configured to enable users to define and/or share keys for a plurality of web pages, or the like. This key manager 108 may collect key definitions as users access search result web pages via one or more search servers, e.g., 106, or access web pages via one or more web servers, e.g., 114. These key definitions may be collected for web pages in any suitable manner. In one example, each web server is configured to allow users to define keys for each provided web page and such keys and their associations with web pages are then forwarded to the key manager 108. In another example, key definitions may be collected from different sources, for example, from databases owned and/or operated by the same or different companies. In yet another example, as key definitions may be associated with one or more objects on a web page, these keys may be managed for these objects even when these objects appear in a different web page. For example, if a key is defined for an image on a web page, the key may be shared when the image is shown on a different web page. As such, the key database 112 can store keys for web pages as well as objects in web pages.

In a specific implementation, one or more clients may be configured with a key agent, e.g., 116. The key agent may be configured to intercept requests from the client for any object, such as a web page to a particular service provider, before forwarding such request to its service provider. For instance, the client browser may include a key agent in the form of a plug-in that receives URL (universal resource locator) requests made by the user for particular web pages. The key agent can as an intermediary software layer between the browser and web (and/or search) servers.

The key agent can be configured to receive each web page from the service provider in response to a request from the user and provide input mechanisms for defining one or more keys for each web page. The key agent may then cause such key definitions to be retained and associated with the web page, as well as with other information such as an identification of the user, the web page identification (e.g., URL) and timestamps for accessing and exiting such result object. The keys and their associated web pages and other related information may then be sent to a central key manager, such as 108 and retained in a central database, such as key database 112. Although the key management module 108 is shown as a separate server, the key management module 108 and/or the key database(s) 112 may be merged with user search server 106 and database(s) 110 and/or key agent 116.

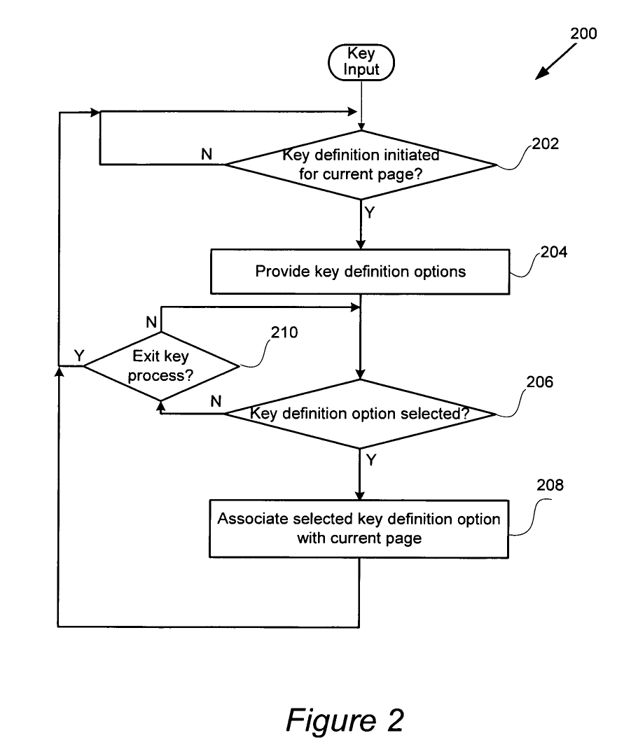

Regardless of the specific architecture, any suitable mechanism for allowing users to define one or more keys with respect to a web page may be provided. FIG. 2 is a flow chart illustrating a key input procedure 200 in accordance with one embodiment of the present invention. Initially, it may be determined whether a key definition has been initiated for the current page, for example, by a user in operation 202. If a key definition has not been initiated, the key input process 200 continues to wait for such initiation in operation 202.

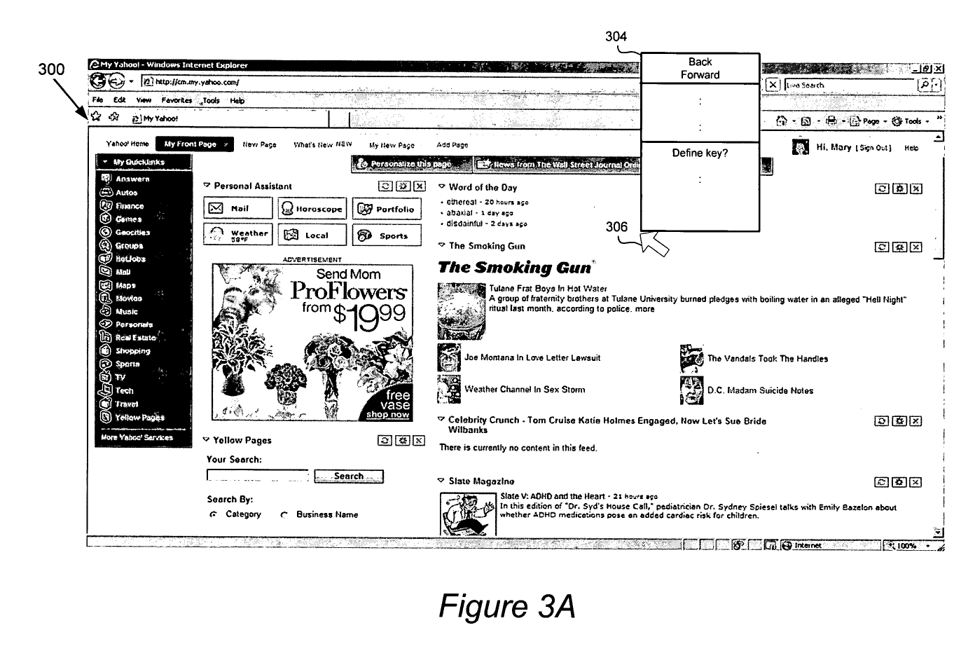

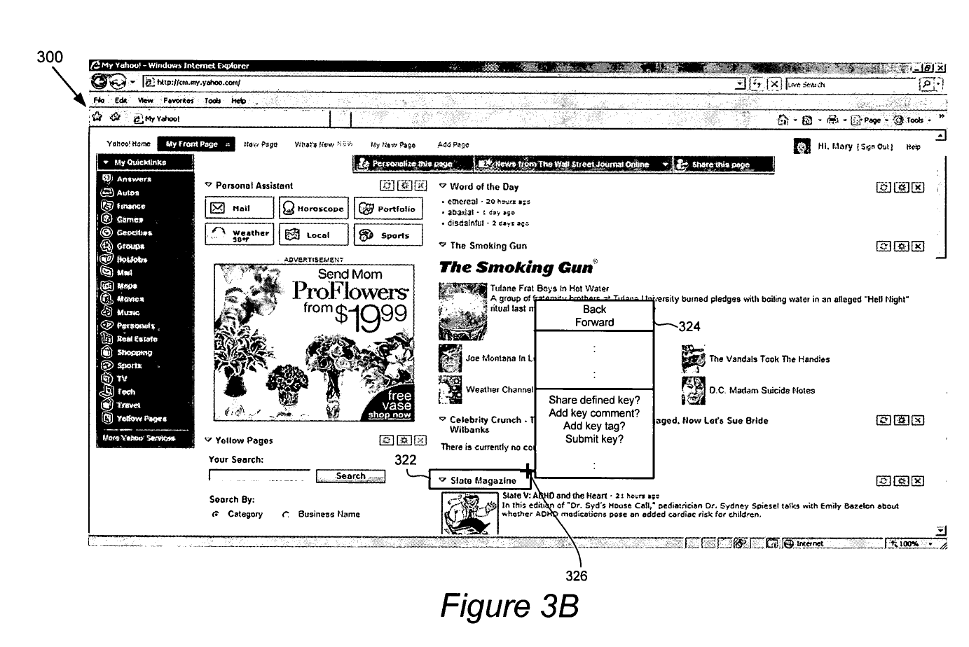

A key definition may be initiated in number of ways. FIG. 3A is a screen shot 300 illustrating a key input mechanism for a particular web page in accordance with one embodiment of the present invention. As shown, general web page options may be displayed in a window 304, for example, when a user right clicks over the displayed web page with their mouse or other pointing device 306. In the illustrated example, the general options window 304 includes an option for defining a key. In this implementation, a user can initiate key definition by selecting this option for defining a key.

In another implementation, a key may simply be initiated and defined by a user's eye movement with respect to the viewed web page. For instance, an eye-tracking web camera may be utilized to track a user's eye movement with respect to positions on the viewed web page. A key may be defined based on any suitable eye movement characteristics, such as time durations or number of repeated viewings for particular portions or objects of the web page. For example, when it is determined that a user has viewed a particular area or object of the web page for more than a predefined amount of time, such particular area or object can be defined as a key. In another example, when a user has had more than a predefined number of repeat viewings of a particular area or object, regardless of the time durations of such viewings, the area or object can be defined as a key. In yet another example, when a user has had more than a predefined number of repeat viewings of a particular area or object and the time durations for such viewings (e.g., average or one or more time durations) is higher than another predefined amount, then such area or object is defined as a key.

Referring back to FIG. 2, key definition options may then be provided after a key definition has been initiated in operation 204. For example, after the user has selected the option for defining keys from the general options window 304 of FIG. 3A, the user may then be presented with various options for defining keys. FIG. 3B illustrates a screen shot that includes various key defining options in accordance with a specific implementation. As shown, the key defining options may include a drawing cursor 326 (e.g., cursor is in the form of “+”) for defining an area 322 of the web page as a key. The defined key 322 may pertain to the underlying area's content. Alternatively, the key defining options may include a mechanism for defining one or more objects, instead of area, of the web page as a key. The defined key objects of the web page may include one or more words or phrases, one or more images, one or more videos, one or more audio links, one or more frames, one or more input boxes, one or more advertising links, one or more software plug-ins, etc.

Other key definition options may also be provided to the user through any suitable interface, such as a pop-up or pull-down window. As shown, when the user right clicks on the web page, a general options window 324 may be presented and include a plurality of selectable key definition options, such as options for sharing the defined key (with different permission settings), adding a comment or tag for the defined key, submitting the key for the current page, submitting the key for the current object, selecting to have the key stored at the user's (client) site or at the content publisher's site or if the key is captured by a key agent, then at the side of the agent manager, etc.

One key option may allow the user to provide a permission setting for a defined key so as to share the key with one or more users or keep the key private. In the illustrated example of FIG. 3B, after the user selects the “share defined key” option, the user may then be presented with a list of sharing options (not shown). The sharing options may take any suitable forms, such as pull-down menus, selection buttons, input boxes, etc. The sharing options may include selectable options for sharing with a specified user, a set of specified users, or any user of the particular web page. A key that has been defined to have a particular permission setting can then be provided to users that meet the requirement of the permission setting for such key. That is, users are only provided with keys when they are specified as having permission for such keys.

Another key definition option may allow the user to add any suitable comments or tags for the currently defined key. By way of examples, the comments or tags may refer to additional information, a review or a metric regarding an object, place, or person that is represented in the web page. For example, the user may add a review about a particular product or service that is represented within the web page. In a specific example, the user may add a review for a particular restaurant that is represented in the web page by an identifying text string (e.g., restaurant name), an image or video of the restaurant, etc. A metric for the key's area or object of interest may include a vote, a ranking value, a score, a time duration, a click frequency, a click count, etc. In a tagging example, a user may select from a predefined list of tags or enter a custom tag. The tag may include any additional information regarding an object, place, or person represented in the web pages, such as providing a category for the object or associating one or more users with the object.

Referring to FIG. 2, it may be determined whether a key definition option has been selected in operation 206. For instance, it may be determined whether a key option of window 324 of FIG. 3B has been selected by the user. If a key option has not been selected, it may be determined whether the key process has been exited in operation 210. For instance, the user may exit the options window 324 by clicking elsewhere on the web page or hitting the “ESC” key. If the key process has been exited, the procedure 200 may return to determining whether another key definition has been initiated again for the current page in operation 202. If the key process has not exited (e.g., the window 324 is still open), the procedure 200 may continue to wait for selection of a key definition option in operation 206.

When a key definition option is selected, the selected key definition option may then be associated with the current page in operation 208. In a specific implementation, this association process may be triggered when the user selects an option for submitting the defined key and its one or more selected key definitions. That is, the user may select a plurality of different key definitions for a particular key before submission. The procedure 200 may also be repeated for the current page. Of course, the process of FIG. 2 may also be applied to a plurality of same or different users as they access the same or different web pages.

In general, one or more keys may be defined by a first user within a first time period with respect to a particular accessed web page (e.g., by inputting key definition information with respect to such web page). The key definitions may be associated with their respect web page area or object, for example, in key database 112. For instance, the key database may include a plurality of entries that each includes a unique key identifier (e.g. randomly or user generated), one or more key definitions (e.g., comments, tags, metrics, etc.), an identifier for the associated web page, and a reference to a specific area or object of the web page. A same or different subsequent user may then access the particular web page during a second time period. In this second time period, the subsequent user may be provided with the one or more keys that were defined and retained during the first time period.

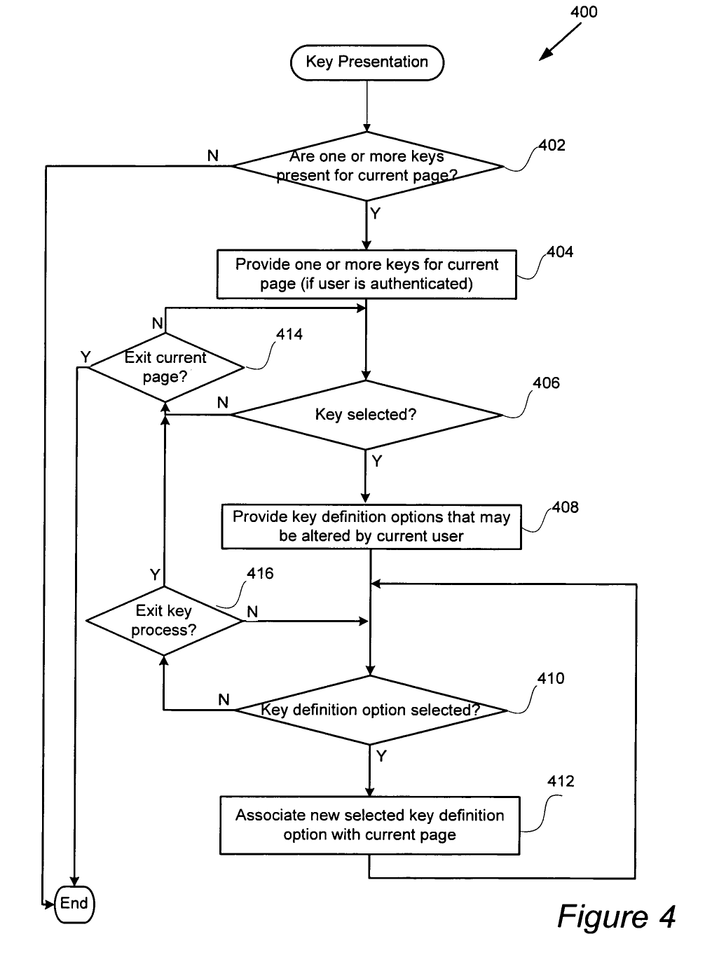

After one or more keys have been defined for a particular web page, one or more of these keys may be shared with one or more users in any suitable manner. FIG. 4 is a flow chart illustrating a key sharing procedure 400 in accordance with a specific implementation of the present invention. Initially, it may be determined whether one or more keys are present for the current page in operation 402. For example, the key database 112 may be searched for keys that are associated with the current page. If no keys are present for the current page, the key presentation procedure 400 ends. If there are keys present, the one or more keys are provided for the current page in operation 404.

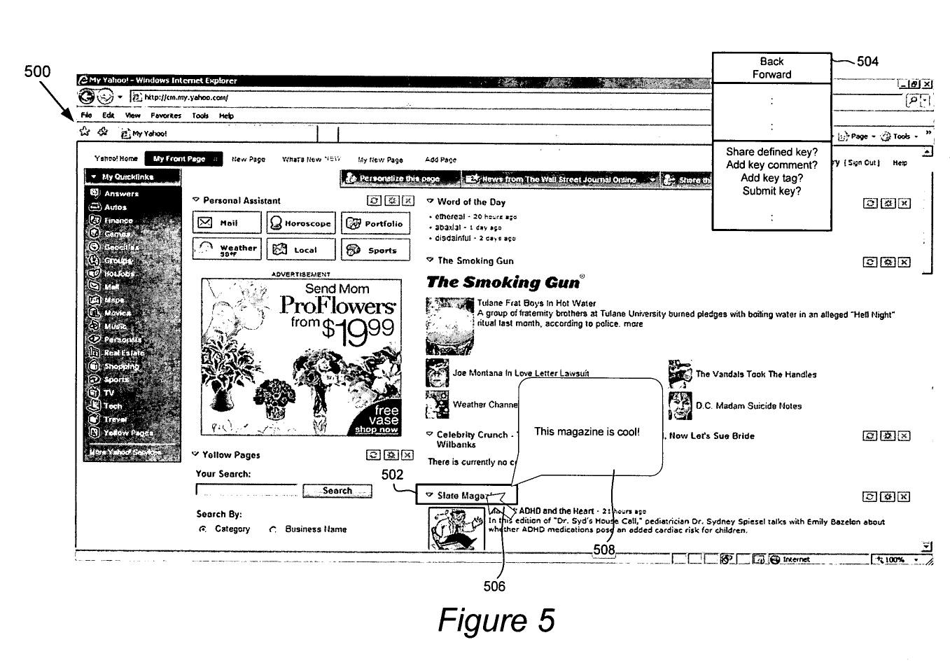

A key and its associated key definition information may be provided in any suitable manner. For example, key information may be statically presented all together or dynamically viewable so that different sets of key information can be selectably shown to the user. FIG. 5 is a screen shot 500 illustrating a web page for which key 502 is provided in accordance with another example embodiment. A key may be highlighted in any suitable manner. In the illustrated embodiment, key 502 pertains to a specific area of the web page (e.g., the text “Slate Magazine”) and is highlighted by a rectangle. Alternatively or additionally, specific area or objects that have been defined as keys may be highlighted using different colors, text, or any suitable symbols for emphasizing an area or object of the web page. In certain embodiments, the user may move their pointer 506 over the key portion (or select the key) and cause one or more additional key definitions to be presented, for example, in a pop up window 508.

Mechanisms may also be provided for altering existing keys of a web page. Of course, a user may also add new keys for areas or objects of a web page that already contains keys for other areas or objects, e.g., new keys can be added by key input procedure 400 of FIG. 4. Referring back to the process of FIG. 4, it may be determined whether a key has been selected (for altering the current set of key definitions for the currently selected key) in operation 406. If a key has not been selected, it may then be determined whether the current page has been exited in operation 414. If the current page has been exited, the key presentation procedure 400 may end. Otherwise, the procedure continues to wait for a key selection (if any).

After a particular key is selected, key definition options that may be altered by the current user may be provided to such user in operation 408. In the example of FIG. 5, the user may be able to select the presented key 502 (e.g., by cursor 506) and choose to alter the key's definitions by right clicking to then cause an option window 504 to be presented. This option window 504 may include a number of key definition options for the selected key, e.g., similar to the key definition options of FIG. 3B. For the selected key, the user can add another key comment or tag, choose sharing options for their additional key definitions, and/or submit their additional key definitions. In addition to options for adding to the key's current set of key definitions, the key definition options may include options for changing a comment or tag that was previously defined for the key. The sharing options may also be redefined for the entire set of key definitions, e.g., provided by previous users and the current user.

Referring to FIG. 4, it may be determined whether a key definition option has been selected in operation 410. For example, it is determined whether the user has selected one of the key definition options of window 504. If a key definition option has not been selected, it may be determined whether the key process has been exited in operation 416. If the key process has been exited, it may then be determined whether the current page has been exited in operation 414. If the current page has been exited, the procedure 400 may end. Otherwise, the procedure may continue to wait for a key definition option selection. When a key definition option has been selected, the new selected key definition option may then be associated with the current page in operation 412.

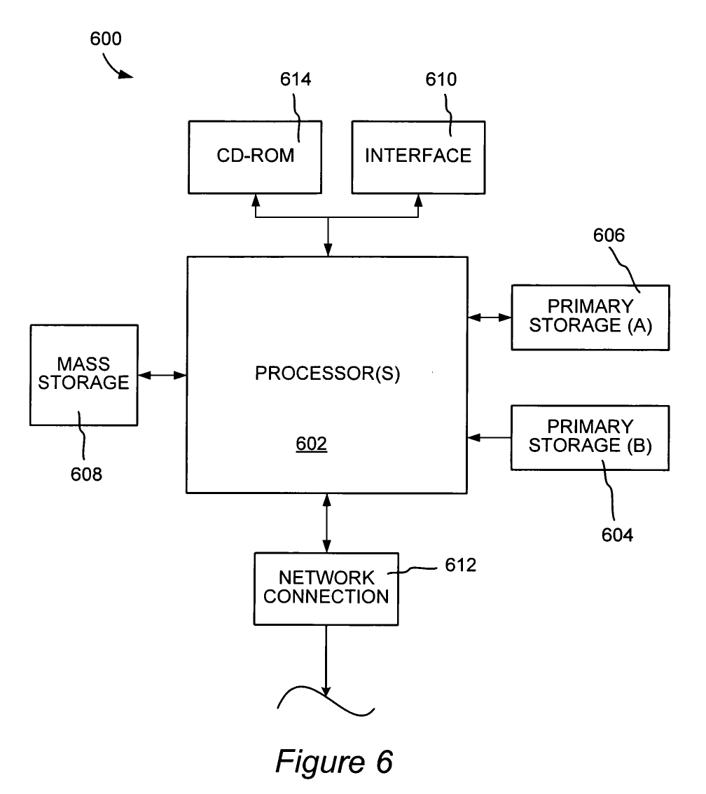

The present invention may be implemented in any suitable combination of hardware and/or software. FIG. 6 illustrates a typical computer system that, when appropriately configured or designed, can serve as a key manager of this invention. The computer system 600 includes any number of processors 602 (also referred to as central processing units, or CPUs) that are coupled to storage devices including primary storage 606 (typically a random access memory, or RAM), primary storage 604 (typically a read only memory, or ROM). CPU 602 may be of various types including microcontrollers and microprocessors such as programmable devices (e.g., CPLDs and FPGAs) and unprogrammable devices such as gate array ASICs or general purpose microprocessors. As is well known in the art, primary storage 604 acts to transfer data and instructions uni-directionally to the CPU and primary storage 606 is used typically to transfer data and instructions in a bi-directional manner. Both of these primary storage devices may include any suitable computer-readable media such as those described above. A mass storage device 608 is also coupled bi-directionally to CPU 602 and provides additional data storage capacity and may include any of the computer-readable media described above. Mass storage device 608 may be used to store programs, data and the like and is typically a secondary storage medium such as a hard disk. It will be appreciated that the information retained within the mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 is also coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications network using an external connection as shown generally at 612. With such a connection, it is contemplated that the CPU might receive information from the network, or might output information to the network in the course of performing the method steps described herein.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store user search database(s), user web information database(s), key database(s), etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave traveling over an appropriate medium such as air, optical lines, electric lines, etc. Examples of program instructions include both machine code, such as produced by a compiler, and files containing higher level code that may be executed by the computer using an interpreter.

Although the foregoing invention has been described in some detail for purposes of clarity of understanding, it will be apparent that certain changes and modifications may be practiced within the scope of the appended claims. In a further embodiment, an entity that is managing keys can sell keys to advertisers (e.g., through bidding for keys). A sponsored key that is sold to a particular buyer or bidder can then include an advertisement on top of the key information (eg., tag or rating, etc.) that may be provided for the associated web object. For instance, the keys can be sold like key words. Additionally, keys can help define a user's intent and be used to rank advertisements on page objects for a page or across multiple pages. The keys can also be analyzed for advertisement purposes, e.g., the objects on a page that have the most keys can be targeted for advertisements. Therefore, the present embodiments are to be considered as illustrative and not restrictive and the invention is not to be limited to the details given herein, but may be modified within the scope and equivalents of the appended claims.

What is claimed is:

1. A method of viewing web pages via a computer network, comprising:
(a) when a particular web page is being accessed during a first time period by a first user, receiving input from the first user for defining a key within the particular web page, wherein the key is an area or one or more objects that are defined as being of interest to the first user; and
(b) when a second user, who differs or is the same as the first user, accesses the particular web page during a subsequent time period, providing the key within the web page to the second user so that the key is provided to the second user as an area or one or more objects of interest within the web page.

2. A method as recited in claim 1, wherein the area or one or more objects of interest is one or more words of the web page that were defined as the key by the first user during the first time period.

3. A method as recited in claim 1, wherein the area or one or more objects of interest is a specific area of the web page that was defined as the key by the first user during the first time period.

4. A method as recited in claim 3, further comprising associating the key with an advertisement from a purchaser of such key, wherein the advertisement is provided with the key to the second user.

5. A method as recited in claim 1, further comprising repeating operation (a) receiving input, from a plurality of first users who are the same or different users, for defining a plurality of keys within the particular web page, wherein the second user is provided with one or more of the keys for such particular web page.

6. A method as recited in claim 1, wherein each of the keys or the entire set of keys include a permission setting that specifies sharing with a specific user, a set of specific users, or any user of the particular web page, and wherein for each of the keys, the second user is only provided with such each key if the second user is specified as having permission for such each key.

7. A method as recited in claim 5, further comprising determining one or more metrics for the keys and providing the one or more metrics to the second user.

8. A method as recited in claim 1, wherein the key includes a comment or tag that is associated with the area or one or more objects of interest.

9. A method as recited in claim 1, wherein receiving the input from the first user is accomplished by tracking eye movement of the first user with respect to the particular web page.

10. An apparatus comprising at least a processor and a memory, wherein the processor and/or memory are configured to perform the following operations:
(a) when a particular web page is being accessed during a first time period by a first user, receiving input from the first user for defining a key within the particular web page, wherein the key is an area or one or more objects that are defined as being of interest to the first user; and
(b) when a second user, who differs or is the same as the first user, accesses the particular web page during a subsequent time period, providing the key within the web page to the second user so that the key is provided to the second user as an area or one or more objects of interest within the web page.

11. An apparatus as recited in claim 10, wherein the area or one or more objects of interest is one or more words of the web page that were defined as the key by the first user during the first time period.

12. An apparatus as recited in claim 10, wherein the area or one or more objects of interest is a specific area of the web page that was defined as the key by the first user during the first time period.

13. An apparatus as recited in claim 12, wherein the processor and/or memory are further configured to associate the key with an advertisement from a purchaser of such key, wherein the advertisement is provided with the key to the second user.

14. An apparatus as recited in claim 10, wherein the processor and/or memory are further configured to repeat operation (a) receiving input, from a plurality of first users who are the same or different users, for defining a plurality of keys within the particular web page, wherein the second user is provided with one or more of the keys for such particular web page.

15. An apparatus as recited in claim 10, wherein each of the keys or the entire set of keys include a permission setting that specifies sharing with a specific user, a set of specific users, or any user of the particular web page, and wherein for each of the keys, the second user is only provided with such each key if the second user is specified as having permission for such each key.

16. An apparatus as recited in claim 14, wherein the processor and/or memory are further configured to determine one or more metrics for the keys and providing the one or more metrics to the second user.

17. An apparatus as recited in claim 10, wherein the key includes a comment or tag that is associated with the area or one or more objects of interest.

18. An apparatus as recited in claim 10, wherein receiving the input from the first user is accomplished by tracking eye movement of the first user with respect to the particular web page.

19. At least one computer readable storage medium having computer program instructions stored thereon that are arranged to perform the following operations:
(a) when a particular web page is being accessed during a first time period by a first user, receiving input from the first user for defining a key within the particular web page, wherein the key is an area or one or more objects that are defined as being of interest to the first user; and
(b) when a second user, who differs or is the same as the first user, accesses the particular web page during a subsequent time period, providing the key within the web page to the second user so that the key is provided to the second user as an area or one or more objects of interest within the web page.

20. At least one computer readable storage medium as recited in claim 19, wherein the area or one or more objects of interest is one or more words of the web page that were defined as the key by the first user during the first time period.

21. At least one computer readable storage medium as recited in claim 19, wherein the area or one or more objects of interest is a specific area of the web page that was defined as the key by the first user during the first time period.

22. At least one computer readable storage medium as recited in claim 21, wherein the computer program instructions stored thereon that are further arranged to associate the key with an advertisement from a purchaser of such key, wherein the advertisement is provided with the key to the second user.

23. At least one computer readable storage medium as recited in claim 19, wherein the computer program instructions stored thereon that are further arranged to repeat operation (a) receiving input, from a plurality of first users who are the same or different users, for defining a plurality of keys within the particular web page, wherein the second user is provided with one or more of the keys for such particular web page.

24. At least one computer readable storage medium as recited in claim 19, wherein each of the keys or the entire set of keys include a permission setting that specifies sharing with a specific user, a set of specific users, or any user of the particular web page, and wherein for each of the keys, the second user is only provided with such each key if the second user is specified as having permission for such each key.

25. At least one computer readable storage medium as recited in claim 23, wherein the computer program instructions stored thereon that are further arranged to determine one or more metrics for the keys and providing the one or more metrics to the second user.

26. At least one computer readable storage medium as recited in claim 19, wherein the key includes a comment or tag that is associated with the area or one or more objects of interest.

27. At least one computer readable storage medium as recited in claim 19, wherein receiving the input from the first user is accomplished by tracking eye movement of the first user with respect to the particular web page.
